(19) United States
(12) Patent Application Publication
(10) Pub. No.: US 2008/0286470 A1
(43) Pub. Date: Nov. 20, 2008

(54) CHEMICAL CONVERSION COATING AGENT AND SURFACE-TREATED METAL

(75) Inventors: Masahiko Matsukawa, Nishitokyo-shi (JP); Kazuhiro Makino, Yokohama-shi (JP); Toshiaki Shimakura, Ichikawa-shi (JP)

Correspondence Address: CONNOLLY BOVE LODGE & HUTZ LLP, 1875 EYE STREET, N.W., SUITE 1100, WASHINGTON, DC, 20006, US

(73) Assignee: Nippon Paint Co., Ltd., Osaka-shi (JP)

(21) Appl. No.: 12/176,911

(22) Filed: Jul. 21, 2008

Related U.S. Application Data
(63) Continuation of application No. 10/743,474, filed on Dec. 23, 2003, now abandoned.

(30) Foreign Application Priority Data
Dec. 24, 2002 (JP) 2002-372768
Dec. 24, 2002 (JP) 2002-372770
Dec. 2, 2003 (JP) 2003-403691

(51) Int. Cl. B05D 3/10

(52) U.S. Cl. 427/327

(57) ABSTRACT

It is an object of the present invention to provide a chemical conversion coating agent which places a less burden on the environment and can apply good chemical conversion treatment to all metals such as iron, zinc and aluminum.

A chemical conversion coating agent comprising:
at least one kind selected from the group consisting of zirconium, titanium and hafnium;
fluorine; and
an adhesion and corrosion resistance imparting agent,
wherein said adhesion and corrosion resistance imparting agent is at least one kind selected from the group consisting of:
1 to 5000 ppm (metal ion concentration) of at least one kind of metal ion (A) selected from the group consisting of zinc ion, manganese ion and cobalt ion;
1 to 5000 ppm (metal ion concentration) of alkaline earth metal ion (B);
1 to 5000 ppm (metal ion concentration) of metal ion (C) of Group III in the periodic table;
0.5 to 100 ppm (metal ion concentration) of copper ion (D); and
1 to 5000 ppm (as a silicon component) of a silicon-containing compound (E).

### TECHNICAL FIELD

The present invention relates to a chemical conversion coating agent and a surface-treated metal.

### BACKGROUND ART

When a cationic electrocoating or a powder coating is applied to the surface of a metal material, a chemical conversion treatment is generally applied in order to improve the properties such as corrosion resistance and adhesion to a coating film. With respect to a chromate treatment used in the chemical conversion treatment, from the viewpoint of being able to further improve the adhesion to a coating film and the corrosion resistance, in recent years, a harmful effect of chromium has been pointed and the development of a chemical conversion coating agent containing no chromium is required. As such a chemical conversion treatment, a treatment using zinc phosphate is widely adopted (cf. Japanese Kokai Publication Hei-10-204649, for instance).

However, since treating agents based on zinc phosphate have high concentrations of metal ions and acids and are very active, these are economically disadvantageous and low in workability in a wastewater treatment. Further, there is a problem of formation and precipitation of salts, being insoluble in water, associated with the metal surface treatment using treating agents based on zinc phosphate. Such a precipitated substance is generally referred to as sludge and increases in cost for removal and disposal of such sludge become problems. In addition, since phosphate ions have a possibility of placing a burden on the environment due to eutrophication, it takes efforts for treating wastewater; therefore, it is preferably not used. Further, there is also a problem that in a metal surface treatment using treating agents based on zinc phosphate, a surface conditioning is required; therefore, a treatment process become long.

As a metal surface treating agent other than such a treating agent based on zinc phosphate or a chemical conversion coating agent of chromate, there is known a metal surface treating agent comprising a zirconium compound (cf. Japanese Kokai Publication Hei-07-310189, for instance). Such a metal surface treating agent comprising a zirconium compound has an excellent property in point of suppressing the generation of the sludge in comparison with the treating agent based on zinc phosphate described above.

However, a chemical conversion coat attained by such a metal surface treating agent comprising a zirconium compound is poor in the adhesion to a coating film attained by various coating methods, and usually less used as a pretreatment step for coating. Particularly, in such the metal surface treating agent comprising a zirconium compound, efforts to improve the adhesion and the corrosion resistance by using it in conjunction with another component such as phosphate ions are being made. However, when it is used in conjunction with the phosphate ions, a problem of the eutrophication will arise as described above. In addition, there has been no study on using such treatment using a metal surface treating agent as a pretreatment method for coating. Further, there was a problem that when an iron material was treated with such the metal surface treating agent, the adequate adhesion to a coating film and the corrosion resistance after coating could not be attained.

As a metal surface treating agent containing a zirconium compound to improve the issue described above, a metal surface treating agent comprising a zirconium compound, vanadium and resin, and containing no phosphate ion, has been developed (cf. Japanese Kokai Publication 2002-60699, for instance). However, since such a metal surface treating agent contains vanadium, it is not preferable in point of causing a problem of a harmful effect on human body and wastewater treatment.

Further, surface treatment of all metals have to be performed by one step of treatment to articles including various metal materials such as iron, zinc and aluminum for bodies and parts of automobiles in some cases. Accordingly there is desired the development of a chemical conversion coating agent which can apply a chemical conversion treatment without problems even in such a case.

### SUMMARY OF THE INVENTION

In consideration of the above circumstances, it is an object of the present invention to provide a chemical conversion coating agent which places a less burden on the environment and can apply good chemical conversion treatment to all metals such as iron, zinc and aluminum.

The present invention is directed to a chemical conversion coating agent comprising:

at least one kind selected from the group consisting of zirconium, titanium and hafnium;

fluorine; and

an adhesion and corrosion resistance imparting agent,

wherein said adhesion and corrosion resistance imparting agent is at least one kind selected from the group consisting of:

1 to 5000 ppm (metal ion concentration) of at least one kind of metal ion (A) selected from the group consisting of zinc ion, manganese ion and cobalt ion;

1 to 5000 ppm (metal ion concentration) of alkaline earth metal ion (B);

1 to 5000 ppm (metal ion concentration) of metal ion (C) of Group III in the periodic table;

0.5 to 100 ppm (metal ion concentration) of copper ion (D); and

1 to 5000 ppm (as a silicon component) of a silicon-containing compound (E).

Preferably, the alkaline earth metal ion (B) is at least one kind selected from the group consisting of magnesium ion, calcium ion, barium ion and strontium ion,

the metal ion (C) of Group III in the periodic table is at least one kind selected from the group consisting of aluminum ion, gallium ion and indium ion, and

the silicon-containing compound (E) is at least one kind selected from the group consisting of silica, water-soluble silicate compounds, esters of silicic acid, alkyl silicates, and silane coupling agents.

Preferably, the chemical conversion coating agent contains

1 to 5000 ppm of at least one kind of a chemical conversion reaction accelerator selected from the group consisting of nitrite ion, nitro group-containing compounds, hydroxylamine sulfate, persulfate ion, sulfite ion, hyposulfite ion, peroxides, iron (III) ion, citric acid iron compounds, bromate ion, perchlorinate ion, chlorate ion, chlorite ion, as well as ascorbic acid, citric acid, tartaric acid, malonic acid, succinic acid and salts thereof.

The present invention is directed to a surface-treated metal comprising

a chemical conversion coat formed by said chemical conversion coating agent on a surface thereof.

Preferably, the chemical conversion coat has a coat amount of 0.1 to 500 mg/m² in a total amount of metals contained in the chemical conversion coating agent.

### DETAILED DESCRIPTION OF THE INVENTION

Hereinafter, the present invention will be described in detail.

The present invention is directed to a chemical conversion coating agent which contains at least one kind selected from the group consisting of zirconium, titanium and hafnium and fluorine, but substantially contains no harmful heavy metal ions such as chromium and vanadium and phosphate ions.

When a surface of metal was treated with a conventionally known chemical conversion coating agent containing zirconium and the like, it was sometimes impossible to form good chemical conversion coat in some metals. Particularly, there was a problem that when an iron material was treated with the above-mentioned chemical conversion coating agent, the adequate adhesion between a coating film to be formed by applying the coating to the surface of the chemical conversion coat and the surface of metal could not be attained.

It is estimated that the presence of fluorine in the chemical conversion coat causes such a problem of being unable to attain the adhesion. In a metal surface treatment by zirconium, for example, it is considered that hydroxide or oxide of zirconium is deposited on the surface of the base material because metal ions elutes in the chemical conversion coating agent through a dissolution reaction of the metal and pH at an interface increases. In this process, fluorine is not entirely replaced with the hydroxide ions; therefore, this means that a certain amount of fluorine is contained in the chemical conversion coat. It is conceivable that since fluorine remains in the chemical conversion coat as described above, when a coating film is formed and the coating film is exposed to a corrosive environment, a hydroxy group generated is further substituted for fluorine to generate fluorine ions, whereby bonding between the coating film and the metal is broken and the adequate adhesion cannot not be attained.

In order to solve the above problems, according to the present invention, a specific metal ion and/or a silicon-containing compound is contained in the chemical conversion coating agent as an adhesion and corrosion resistance imparting agent to significantly improve the adhesion between the coating film and the metal material.

At least one kind selected from the group consisting of zirconium, titanium and hafnium contained in the chemical conversion coating agent is a component constituting chemical conversion coats and, by forming a chemical conversion coat including at least one kind selected from the group consisting of zirconium, titanium and hafnium on a material, the corrosion resistance and abrasion resistance of the material can be improved and, further, the adhesion to the coating film formed subsequently can be enhanced.

A supply source of the zirconium is not particularly limited, and examples thereof include alkaline metal fluoro-zirconate such as K₂ZrF₆, fluoro-zirconate such as (NH₄)₂ZrF₆, soluble fluoro-zirconate like fluoro-zirconate acid such as H₂ZrF₆, zirconium fluoride, zirconium oxide and the like.

A supply source of the titanium is not particularly limited, and examples thereof include alkaline metal fluoro-titanate, fluoro-titanate such as (NH₄)₂TiF₆, soluble fluoro-titanate like fluoro-titanate acid such as H₂TiF₆, titanium fluoride, titanium oxide and the like.

A supply source of the hafnium is not particularly limited, and examples thereof include fluoro-hafnate acid such as H₂HfF₆, hafnium fluoride and the like.

As a supply source of at least one kind selected from the group consisting of zirconium, titanium and hafnium, a compound having at least one kind selected from the group consisting of ZrF₆²⁻, TiF₆²⁻ and HfF₆²⁻ is preferable because of high ability of forming a coat.

Preferably, the content of at least one kind selected from the group consisting of zirconium, titanium and hafnium, which is contained in the chemical conversion coating agent is within a range from 20 ppm of a lower limit to 10000 ppm of an upper limit in terms of metal. When the content is less than the above lower limit, the performance of the chemical conversion coat to be obtained is inadequate, and when the content exceeds the above upper limit, it is economically disadvantageous because further improvements of the performances cannot be expected. More preferably, the lower limit is 50 ppm and the upper limit is 2000 ppm.

Fluorine contained in the chemical conversion coating agent plays a role as an etchant of a material. A supply source of the fluorine is not particularly limited, and examples thereof include fluorides such as hydrofluoric acid, ammonium fluoride, fluoboric acid, ammonium hydrogenfluoride, sodium fluoride, sodium hydrogenfluoride and the like. In addition, an example of complex fluoride includes hexa fluorosilicate, and specific examples thereof include hydrosilicofluoric acid, zinc hydrosilicofluoride, manganese hydrosilicofluoride, magnesium hydrosilicofluoride, nickel hydrosilicofluoride, iron hydrosilicofluoride, calcium hydrosilicofluoride and the like.

The chemical conversion coating agent of the present invention contains the at least one kind selected from the group consisting of zirconium, titanium and hafnium as well as the fluorine, and further contains an adhesion and corrosion resistance imparting agent. The adhesion and corrosion resistance imparting agent is at least one kind selected from the group consisting of: at least one kind of metal ion (A) selected from the group consisting of zinc ion, manganese ion and cobalt ion; alkaline earth metal ion (B); metal ion (C) of Group III in the periodic table; copper ion (D); and a silicon-containing compound (E). By containing these compounds, the adhesion to the coating film and the corrosion resistance after coating are significantly improved.

It is estimated that such a effect can be attained because a concentration of fluorine in the chemical conversion coat is lowered by blending the adhesion and corrosion resistance imparting agent, and the problem of adversely affecting the coating film and the surface of metal due to the generation of fluorine during curing of a coating film by heating is resolved. In addition, it is estimated that elements of the adhesion and corrosion resistance imparting agent are mixed in the coat, so that this causes chemical stability of the coat to increase and the porosity of the coat to decrease resulting in improvements in performances after coating.

The at least one kind of metal ion (A) selected from the group consisting of zinc ion, manganese ion and cobalt ion is a metal ion having a valence of bivalence or trivalence and, more specifically, at least one kind of metal ion selected from the group consisting of Zn²⁺, Mn²⁺, Co²⁺, Co³⁺ and the like. Among the above-mentioned ions, the zinc ion is preferable in that particularly good adhesion can be attained. The content of the metal ion (A) in the chemical conversion coating agent is within a range from 1 ppm of a lower limit to 5000 ppm of an upper limit. When the content is less than 1 ppm, it is not preferable because the corrosion resistance of the chemical conversion coat to be obtained is deteriorated. When the content exceeds 5000 ppm, it is economically disadvantageous because further improvements of the performances are not recognized; and, there is a possibility that the adhesion after coating is deteriorated. Preferably, the above-mentioned lower limit is 20 ppm and the above-mentioned upper limit is 2000 ppm.

The alkaline earth metal ion (B) is not particularly limited, and examples thereof may include magnesium ion, calcium ion, barium ion, strontium ion and the like. Particularly, the magnesium ion is preferable. The content of the alkaline earth metal ion (B) is within a range from 1 ppm of a lower limit to 5000 ppm of an upper limit. When the content is less than 1 ppm, it is not preferable because the corrosion resistance of the chemical conversion coat to be obtained is deteriorated. When the content exceeds 5000 ppm, it is economically disadvantageous because further improvements of the performances are not recognized; and, there is a possibility that the adhesion after coating is deteriorated. Preferably, the above-mentioned lower limit is 20 ppm and the above-mentioned upper limit is 2000 ppm.

Examples of the metal ion (C) of Group III in the periodic table may include aluminum ion, gallium ion and indium ion. The content of the metal ion (C) of Group III in the periodic table is within a range from 1 ppm of a lower limit to 5000 ppm of an upper limit. When the content is less than 1 ppm, it is not preferable because the corrosion resistance of the chemical conversion coat to be obtained is deteriorated. When the content exceeds 5000 ppm, it is economically disadvantageous because further improvements of the performances are not recognized and, in some cases, the adhesion after coating is deteriorated. Preferably, the above-mentioned lower limit is 5 ppm and the above-mentioned upper limit is 2000 ppm.

The content of the copper ion (D) is within a range from 0.5 ppm of a lower limit to 100 ppm of an upper limit. When the content is less than 0.5 ppm, it is not preferable because the corrosion resistance of the chemical conversion coat to be obtained is deteriorated. When the content exceeds 100 ppm, there is a possibility that a negative effect is brought in a zinc material and an aluminum material. Preferably, the above-mentioned lower limit is 2 ppm and the above-mentioned upper limit is 50 ppm. It is estimated that the copper ion stabilizes rust formed through the corrosion of iron by being displacement-plated to the surface of metal, thereby suppressing the corrosion of iron. Therefore, it is estimated that the copper ion can attain a high degree of effectiveness in a small amount in comparison with another metal ion components.

A supply source of the respective metal ion components (A), (B), (C) and (D) is not particularly limited and, for example, they can be blended in the chemical conversion coating agent as nitrate, sulfate or fluoride. Among them, nitrate is preferable because it does not adversely affect chemical conversion reaction.

The silicon-containing compound (E) is not particularly limited, and examples thereof include silica such as water-dispersed silica, water-soluble silicate compounds such as sodium silicate, potassium silicate and lithium silicate, esters of silicic acid, alkyl silicates such as diethyl silicate, a silane coupling agent, and the like. Among them, silica is preferable since it has an action of enhancing a barrier-effect of a chemical conversion coat and water-dispersed silica is more preferable since it has high dispersibility in the chemical conversion coating agent. The water-dispersed silica is not particularly limited, and examples thereof include spherical silica, chain silica, aluminum-modified silica and the like, which have less impurities such as sodium. The spherical silica is not particularly limited, and examples thereof include colloidal silica such as “SNOWTEX N”, “SNOWTEX O”, “SNOWTEX OXS”, “SNOWTEX UP”, “SNOWTEX XS”, “SNOWTEX AK”, “SNOWTEX OUP”, “SNOWTEX C” and “SNOWTEX OL” (each manufactured by Nissan Chemical Industries Co., Ltd.) and fumed silica such as “AEROSIL” (manufactured by Nippon Aerosil Co., Ltd.), and the like. The chain silica is not particularly limited, and examples thereof include silica sol such as “SNOWTEX PS-M”, “SNOWTEX PS-MO”, “SNOWTEX PS-SO” (each manufactured by Nissan Chemical Industries Co., Ltd.), and the like. Examples of the aluminum-modified silica include commercially available silica sol such as “ADELITE AT-20A” (manufactured by Asahi Denka Co., Ltd.), and the like. Although the silicon-containing compound may be used alone, it exerts more excellent effects when it is used in combination with the above-mentioned metal ions (A) to (D).

The content of the silicon-containing compound (E) is within a range from 1 ppm of a lower limit to 5000 ppm of an upper limit as a silicon component. When the content is less than 1 ppm, it is not preferable because the corrosion resistance of the chemical conversion coat to be obtained is deteriorated. When the content exceeds 5000 ppm, it is economically disadvantageous because further improvements of the performances are not recognized; and, there is a possibility that adhesion after coating is deteriorated. Preferably, the above-mentioned lower limit is 5 ppm and the above-mentioned upper limit is 2000 ppm.

The respective components (A) to (E) may be used alone or in combination of two or more kinds of components as required. When two or more kinds of components are used simultaneously, the contents of the respective components need to be within the above-mentioned ranges, respectively, and the total amount of the respective components is not particularly limited.

Particularly, although the silicon-containing compound (E) may be used alone, an effect of improving the adhesion can be more efficiently exerted when it is used in combination with the metal ions (A) to (D). An example of the most preferable combination include a combination of at least one kind of metal ion (A) selected from the group consisting of zinc ion, manganese ion and cobalt ion and alkaline earth metal ion (B).

Preferably, the chemical conversion coating agent of the present invention further contains a chemical conversion reaction accelerator. The chemical conversion reaction accelerator has an effect of suppressing unevenness of the surface of a chemical conversion coat obtained using a metal surface treating agent comprising a zirconium compound. An amount of a coat precipitated is different depending on the difference of location between an edge portion and a flat portion of a material; thereby, the unevenness of the surface is generated. Therefore, when a metal material having an edge portion is treated with a conventional surface treating agent comprising a zirconium compound, since an anodic dissolution reaction occurs selectively at an edge portion, a cathodic reaction becomes prone to occur and, consequently, a coat tends to precipitate around the edge portion and an anodic dissolution reaction hardly occur in a flat portion and precipitation of a coat is suppressed, and this results in unevenness of the surface.

In the chemical conversion treatment of zinc phosphate, since the resulting chemical conversion coat is a thick film type, the unevenness of the surface does not turn into problems so much. However, since the chemical conversion coat comprising a zirconium compound is a thin film type, when a sufficient amount of a coat is not attained at a flat portion to which the chemical conversion treatment is hardly applied, this causes uneven coating and problems may arise in appearance of a coating and corrosion resistance.

The chemical conversion reaction accelerator in the present invention has a property to act in such a manner that the chemical conversion treatment may be applied without developing a difference of a chemical conversion treatment reaction between the edge portion and the flat portion described above by being blended in the chemical conversion coating agent.

Although the chemical conversion reaction accelerator is at least one kind selected from the group consisting of nitrite ions, nitro group-containing compounds, hydroxylamine sulfate, persulfate ions, sulfite ions, hyposulfite ions, peroxides, iron (III) ions, citric acid iron compounds, bromate ions, perchlorinate ions, chlorate ions, chlorite ions as well as ascorbic acid, citric acid, tartaric acid, malonic acid, succinic acid and salts thereof, in particular, a substance having an oxidizing action or an organic acid is preferable for accelerating etching efficiently.

By blending these chemical conversion reaction accelerators in the chemical conversion coating agent, unbalanced coat-precipitation is adjusted and good chemical conversion coat having no unevenness in an edge portion and a flat portion of a material can be attained.

A supply source of the nitrite ion is not particularly limited, and examples thereof include sodium nitrite, potassium nitrite, ammonium nitrite and the like. The nitro group-containing compound is not particularly limited, and examples thereof include nitrobenzenesulfonic acid, nitroguanidine and the like. A supply source of the persulfate ion is not particularly limited, and examples thereof include Na₂S₂O₈, K₂S₂O₈ and the like. A supply source of the sulfite ion is not particularly limited, and examples thereof include sodium sulfite, potassium sulfite, ammonium sulfite and the like. A supply source of the hyposulfite ion is not particularly limited, and examples thereof include sodium hyposulfite, potassium hyposulfite, ammonium hyposulfite and the like. The peroxides is not particularly limited, and examples thereof include hydrogen peroxide, sodium peroxide, potassium peroxide and the like.

A supply source of the iron (III) ion is not particularly limited, and examples thereof include ferric nitrate, ferric sulfate, ferric chloride and the like. The citric acid iron compound is not particularly limited, and examples thereof include citric acid iron ammonium, citric acid iron sodium, citric acid iron potassium and the like. A supply source of the bromate ion is not particularly limited, and examples thereof include sodium bromate, potassium bromate, ammonium bromate and the like. A supply source of the perchlorinate ion is not particularly limited, and examples thereof include sodium perchlorinate, potassium perchlorinate, ammonium perchlorinate and the like.

A supply source of the chlorate ion is not particularly limited, and examples thereof include sodium chlorate, potassium chlorate, ammonium chlorate and the like. A supply source of the chlorite ion is not particularly limited, and examples thereof include sodium chlorite, potassium chlorite, ammonium chlorite and the like. The ascorbic acid and salt thereof are not particularly limited, and examples thereof include ascorbic acid, sodium ascorbate, potassium ascorbate, ammonium ascorbate and the like. The citric acid and salt there, of are not particularly limited, and examples thereof include citric acid, sodium citrate, potassium citrate, ammonium citrate and the like. The tartaric acid and salt thereof are not particularly limited, and examples thereof include tartaric acid, ammonium tartrate, potassium tartrate, sodium tartrate and the like. The malonic acid and salt thereof are not particularly limited, and examples thereof include malonic acid, ammonium malonate, potassium malonate, sodium malonate and the like. The succinic acid and salt thereof are not particularly limited, and examples thereof include succinic acid, sodium succinate, potassium succinate, ammonium succinate and the like.

The above-described chemical conversion reaction accelerators may be used alone or in combination of two or more kinds of components as required.

A blending amount of the chemical conversion reaction accelerator in the chemical conversion coating agent of the present invention is preferably within a range from 1 ppm of a lower limit to 5000 ppm of an upper limit. When it is less than 1 ppm, it is not preferred because an adequate effect cannot be attained. When it exceeds 5000 ppm, there is a possibility of inhibiting coat formation. The above lower limit is more preferably 3 ppm and further more preferably 5 ppm. The above upper limit is more preferably 2000 ppm and further more preferably 1500 ppm.

Preferably, the chemical conversion coating agent of the present invention does not substantially contain phosphate ions. Not substantially containing means that phosphate ions are not contained to such an extent that the phosphate ions act as a component in the chemical conversion coating agent. When the above chemical conversion coating agent does not substantially contain phosphate ions, phosphorus causing a burden on the environment is not substantially used and the formation of the sludge such as iron phosphate and zinc phosphate, formed in using a treating agent of zinc phosphate, can be suppressed.

In the chemical conversion coating agent of the present invention, preferably, a pH is within a range from 1.5 of a lower limit to 6.5 of an upper limit. When the pH is less than 1.5, etching becomes excessive; therefore, adequate coat formation becomes impossible. When it exceeds 6.5, etching becomes insufficient; therefore, a good coat cannot be attained. More preferably, the above lower limit is 2.0 and the above upper limit is 5.5. Still more preferably, the above lower limit is 2.5 and the above upper limit is 5.0. In order to control a pH, there can be used acidic compounds such as nitric acid and sulfuric acid, and basic compounds such as sodium hydroxide, potassium hydroxide and ammonia.

A chemical conversion treatment of metal using the chemical conversion coating agent is not particularly limited, and this can be performed by bringing a chemical conversion coating agent into contact with a surface of metal in usual treatment conditions. Preferably, a treatment temperature in the above-mentioned chemical conversion treatment is within a range from 20° C. of a lower limit to 70° C. of an upper limit. More preferably, the above-mentioned lower limit is 30° C. and the above-mentioned upper limit is 50° C. Preferably, a chemical conversion time in the chemical conversion treatment is within a range from 5 seconds of a lower limit to 1,200 seconds of an upper limit. More preferably, the above-mentioned lower limit is 30 seconds and the above-mentioned upper limit is 120 seconds. The treatment method is not particularly limited, and examples thereof include an immersion method, a spray coating method, a roller coating method and the like.

The present invention is also directed to a surface-treated metal comprising the chemical conversion coat formed by the above-mentioned chemical conversion coating agent on a surface thereof. The surface of the surface-treated metal is preferably degreased and rinsed with water after being degreased, before the chemical conversion treatment is applied using the chemical conversion coating agent; and is postrinsed after the chemical conversion treatment.

The above-mentioned degreasing is performed to remove an oil matter or a stain adhered to the surface of the material, and an immersion treatment is performed usually at 30 to 55° C. for about several minutes with a degreasing agent such as phosphate-free and nitrogen-free cleaning liquid for degreasing. It is also possible to perform pre-degreasing before degreasing as required.

The above-mentioned rinsing with water after degreasing is performed by spraying once or more with a large amount of water for rinsing in order to rinse a degreasing agent after degreasing.

The above-mentioned postrinsing after the chemical conversion treatment is performed once or more in order to prevent the chemical conversion treatment from adversely affecting to the adhesion and the corrosion resistance after the subsequent various coating applications. In this case, it is proper to perform the final rinsing with pure water. In this postrinsing after the chemical conversion treatment, either spray rinsing or immersion rinsing may be used, and a combination of these rinsing may be adopted.

In addition, since the chemical conversion treatment using the chemical conversion coating agent of the present invention does not need to conduct a surface conditioning which is required in a method of treating using the zinc phosphate-based chemical conversion coating agent which is conventionally in the actual use, the chemical conversion treatment of metal can be performed in fewer steps.

In the chemical conversion treatment using the chemical conversion coating agent of the present invention, a drying step after the above-mentioned postrinsing after the chemical conversion treatment is not necessarily required. Even though coating is performed with the chemical conversion coats being wet without drying, the resulting performance is not affected. When drying is performed, it is preferable to dry with cool air or hot air. When the hot air drying is selected, air temperature is preferably 300° C. or less from the viewpoint of saving thermal energy.

Examples of a metal material treated with the chemical conversion coating agent of the present invention include an iron material, an aluminum material, a zinc material and the like. Iron, aluminum and zinc materials mean an iron material in which a material comprises iron and/or its alloy, an aluminum material in which a material comprises aluminum and/or its alloy and a zinc material in which a material comprises zinc and/or its alloy, respectively. The chemical conversion coating agent of the present invention can also be used for chemical conversion treatment of a substance to be coated comprising a plurality of metal materials among the iron material, the aluminum material and the zinc material.

The chemical conversion coating agent of the present invention is preferable in point of being able to impart the sufficient adhesion to a coating film to iron materials for which pretreatment by the conventional chemical conversion coating agent containing zirconium and the like is not suitable; therefore, it can also be applied for treating a substance containing an iron material at least in part. Accordingly, the chemical conversion coating agent of the present invention has an excellent property particularly in application to iron materials. A surface-treated metal having the chemical conversion coat formed by using the chemical conversion coating agent of the present invention is also one of the present invention.

The iron material is not particularly limited, and examples thereof include a cold-rolled steel sheet, a hot-rolled steel sheet and the like. The aluminum material is not particularly limited, and examples thereof include 5000 series aluminum alloy, 6000 series aluminum alloy and the like. The zinc material is not particularly limited, and examples thereof include steel sheets, which are plated with zinc or a zinc-based alloy through electroplating, hot dipping and vacuum evaporation coating, such as a galvanized steel sheet, a steel sheet plated with a zinc-nickel alloy, a steel sheet plated with a zinc-iron alloy, a steel sheet plated with a zinc-chromium alloy, a steel sheet plated with a zinc-aluminum alloy, a steel sheet plated with a zinc-titanium alloy, a steel sheet plated with a zinc-magnesium alloy and a steel sheet plated with a zinc-manganese alloy, and the like. By using the above chemical conversion coating agent, chemical conversion treatment with iron, aluminum and zinc materials can be conducted simultaneously.

Preferably, a coat amount of the chemical conversion coat attained by the chemical conversion coating agent of the present invention is within a range from 0.1 mg/m² of a lower limit to 500 mg/m² of an upper limit in a total amount of metals contained in the chemical conversion coating agent. When this amount is less than 0.1 mg/m², it is not preferable because a uniform chemical conversion coat cannot be attained. When it exceeds 500 mg/m², it is economically disadvantageous. More preferably, the above-mentioned lower limit is mg/m² and the above-mentioned upper limit is 200 mg/m².

Coating, which can be applied to a metal material having the chemical conversion coat formed by the chemical conversion coating agent of the present invention, is not particularly limited, and examples thereof may include conventionally publicly known coating such as cationic electrocoating, powder coating and the like. Particularly, since the chemical conversion coating agent of the present invention can apply good treatment to all metals such as iron, zinc and aluminum, it can be favorably used as pretreatment of cationic electrocoating of a substance to be treated at least a part of which comprising an iron material. The cationic electrocoating is not particularly limited, and examples thereof may include a conventionally publicly known cationic electrodeposition coating composition comprising aminated epoxy resin, aminated acrylic resin, sulfonated epoxy resin and the like.

The chemical conversion coating agent of the present invention is a chemical conversion coating agent comprising at least one kind selected from the group consisting of zirconium, titanium and hafnium, fluorine, and an adhesion and corrosion resistance imparting agent and, by improving the stability of the resulting chemical conversion coat, it can form a chemical conversion coat, which is high in the corrosion resistance and the adhesion after coating, even for iron materials for which pretreatment by the conventional chemical conversion coating agent containing zirconium and the like is not suitable.

Since the chemical conversion coating agent of the present invention contains no phosphate ions, the burden on the environment is less and the sludge is not formed. In addition, the chemical conversion treatment using the chemical conversion coating agent of the present invention can perform the chemical conversion treatment of metal material in fewer steps since it does not require the surface conditioning.

In accordance with the present invention, the chemical conversion coating agent which places a less burden on the environment and does not generate sludge could be attained. It is possible to form the chemical conversion coat, which is high in the stability as a coat and the adhesion to a coating film even for iron materials, by using the chemical conversion coating agent of the present invention. Since a good chemical conversion coat is formed without a surface conditioning in chemical conversion treatment using the chemical conversion coating agent of the present invention, the chemical conversion treatment using the chemical conversion coating agent is excellent in workability and cost.

### EXAMPLES

Hereinafter, the present invention will be described in more detail by way of examples, but the present invention is not limited to these examples. Herein, a term “part” means “part bymass” and “%” means “% bymass” in the examples, unless otherwise specified.

### Examples 1 to 28, Comparative Examples 5 to 13

A commercially available cold-rolled steel sheet (SPCC-SD, manufactured by Nippon Testpanel Co., Ltd., 70 mm×150 mm×0.8 mm), a galvanized steel sheet (GA steel sheet, manufactured by Nippon Testpanel Co., Ltd., 70 mm×150 mm×0.8 mm), 5000 series aluminum (manufactured by Nippon Testpanel Co., Ltd., 70 mm×150 mm×0.8 mm) or 6000 series aluminum (manufactured by Nippon Testpanel Co., Ltd., 70 mm×150 mm×0.8 mm) were used as a base material, respectively, and pretreatment of coating was applied to these materials in the following conditions.

### (1) Pretreatment of Coating

Degreasing treatment: The metal materials Were immersed at 40° C. for 2 minutes with 2% by mass “SURF CLEANER EC92” (degreasing agent manufactured by Nippon Paint Co., Ltd.).

Rinsing with water after degreasing: The metal materials were rinsed for 30 seconds with a spray of running water.

Chemical conversion treatment: Chemical conversion coating agents having compositions shown in Tables 1 to 3 were prepared by using fluorozirconic acid and fluorotitanic acid as a component constituting a coat, nitrates of metals, SiO₂ (W) (manufactured by Nissan Chemical Industries Co., Ltd.) and SiO₂ (D) (manufactured by Nippon Aerosil Co., Ltd.), which were respectively commercial silica, and diethyl silicate as a silicon-containing compound, and KBP-90 (manufactured by Shin-Etsu Chemical Co., Ltd.) as a silane coupling agent. Chemical conversion reaction accelerators to be used were A: citric acid iron (III) ammonium, B: sodium nitrite, C: ammonium persulfate, D: sodium bromate, E: sodium chlorate, F: tartaric acid, and G: nitroguanidine. A pH was adjusted so as to be 2.5 to 5.5 by using nitric acid or sodium hydroxide. Temperatures of the resulting chemical conversion coating agents were controlled at 25 to 75° C. and each metal material was immersed for 10 to 1,500 seconds. The concentrations of each metal component and the silicon-containing compound represent concentrations as a metal ion and as a silicon component.

Rinsing after chemical conversion: The metal materials were rinsed for 30 seconds with a spray of running water. In addition, they were rinsed for 30 seconds with a spray of ion-exchanged water.

Drying: Prepared were the metal materials after rinsing which were sent to a subsequent coating step as is wet without being dried; the metal materials which were dried with cool air; and the metal materials which were dried with hot air at 80° C. for 5 minutes using a hot air dryer. It is noted that a coat amount was analyzed as a total amount of metals contained in the chemical conversion coating agent by using “XRF-1700” (X-ray fluorescence spectrometer manufactured by Shimadzu Co., Ltd.) (2) Coating

After 1 m² of the surface of the metal materials were treated per 1 liter of the chemical conversion coating agent, electrocoating was applied to the surface in such a manner that a dried film thickness was 20 μm using “POWERNIX 110” (a cationic electrodeposition coating composition manufactured by Nippon Paint Co., Ltd.) and, after rinsing with water, the metal materials were heated and baked at 170° C. for 20 minutes and test sheets were prepared.

### Comparative Examples 1 to 4

Test sheets were obtained by following the same procedure as that of the above-described examples except that chemical conversion treatment was conducted by conditioning the surface at a room temperature for 30 seconds using “SURF FINE 5N-8M” (manufactured by Nippon Paint Co., Ltd.) after rinsing with water after degreasing and by immersing the test sheets at 35° C. for 2 minutes using “SURF DYNE SD-6350” (a zinc phosphate-based chemical conversion coating agent manufactured by Nippon Paint Co., Ltd.). The used materials, pHs of the chemical conversion coating agents, treatment conditions and drying conditions are as shown in Table 3.

TABLE 1

| | | | Composition of treating agent (ppm) | | | | | | | | | |
|---|---|---|---|---|---|---|---|---|---|---|---|---|
| | | | | | | | | | | | SiO₂ | SiO₂ |
| | | Material | Zr | Ti | Zn | Mn | Co | Mg | Ca | Ba | (D) | (W) |
| Example | 1 | SPC Steel sheet | 250 | — | 500 | — | — | — | — | — | — | — |
| | 2 | SPC steel sheet | 250 | — | 500 | — | — | — | — | — | 200 | — |
| | 3 | SPC steel sheet | 200 | — | — | — | — | 500 | — | — | 200 | — |
| | 4 | SPC steel sheet | 250 | — | — | — | — | — | 100 | — | — | 100 |
| | 5 | SPC steel sheet | 250 | — | 1000 | — | — | 500 | — | — | 300 | — |
| | 6 | SPC steel sheet | 250 | — | 500 | — | — | | — | — | 200 | — |
| | 7 | 6000 series aluminum | 500 | — | — | — | — | 500 | — | — | — | 200 |
| | 8 | 5000 series aluminum | 4000 | — | — | 30 | — | — | — | 100 | — | — |
| | 9 | 5000 series aluminum | 30 | — | 100 | — | — | 100 | — | — | 200 | — |
| | 10 | SPC steel sheet | 500 | — | — | — | — | 1000 | 500 | — | — | — |
| | 11 | SPC steel sheet | 500 | — | 1000 | — | — | 500 | — | — | — | — |
| | 12 | GA steel sheet | 500 | — | 1000 | — | — | 500 | — | — | — | — |
| | 13 | GA steel sheet | 1000 | — | 1000 | — | — | 500 | — | — | — | — |
| | 14 | SPC steel sheet | 1000 | 100 | 1000 | — | — | 500 | — | — | — | — |
| | 15 | SPC steel sheet | — | 100 | 100 | — | — | 100 | | — | — | 30 |

| | |
|---|---|
| | Treatment |
| Composition of treating agent (ppm) | condition |

| | | Sodium- | | | Diethyl- | | | | | Temper- | |
|---|---|---|---|---|---|---|---|---|---|---|---|
| | | sili- | | | sili- | | Acceler- | | Time | ature | |
| | | cate | Al | In | cate | Cu | ator | pH | (sec) | (° C.) | Drying |
| Example | 1 | — | — | — | — | — | — | 4 | 60 | 40 | Air |
| | | | | | | | | | | | drying |
| | 2 | — | — | — | — | — | — | 4 | 60 | 40 | None |
| | 3 | — | — | — | — | — | — | 4 | 60 | 40 | 80° C. |
| | 4 | — | — | — | — | — | — | 4 | 60 | 40 | Air |
| | | | | | | | | | | | drying |
| | 5 | — | 5 | — | — | 1 | — | 4 | 60 | 40 | Air |
| | | | | | | | | | | | drying |
| | 6 | — | — | — | — | 5 | — | 4 | 60 | 40 | None |
| | 7 | — | | — | — | 45 | — | 4 | 10 | 25 | None |
| | 8 | 30 | — | — | — | — | — | 4 | 20 | 40 | Air |
| | | | | | | | | | | | drying |
| | 9 | — | — | — | — | — | — | 5.5 | 10 | 40 | Air |
| | | | | | | | | | | | drying |
| | 10 | — | — | — | — | — | — | 4 | 60 | 40 | Air |
| | | | | | | | | | | | drying |
| | 11 | — | — | — | — | — | — | 4 | 60 | 40 | Air |
| | | | | | | | | | | | drying |
| | 12 | — | 100 | — | — | — | — | 3.5 | 90 | 40 | None |
| | 13 | — | 900 | — | — | — | — | 3 | 90 | 35 | 80° C. |
| | 14 | — | — | 3 | — | — | — | 4.5 | 60 | 40 | Air |
| | | | | | | | | | | | drying |
| | 15 | — | — | — | — | — | — | 4 | 60 | 40 | Air |
| | | | | | | | | | | | drying |

TABLE 2

| | | | Composition of treating agent (ppm) | | | | | | | | | |
|---|---|---|---|---|---|---|---|---|---|---|---|---|
| | | | | | | | | | | | | Silane |
| | | | | | | | | | | | SiO₂ | coupling |
| | | Material | Zr | Ti | Zn | Mn | Co | Mg | Ca | Ba | (D) | agent |
| Example | 16 | GA steel | — | 500 | — | — | 100 | — | 100 | — | 300 | — |
| | | sheet | | | | | | | | | | |
| | 17 | GA steel | — | 1000 | 4000 | — | — | 30 | — | — | 4000 | — |
| | | sheet | | | | | | | | | | |
| | 18 | SPC | 500 | — | 500 | — | — | — | — | — | 1000 | — |
| | | steel | | | | | | | | | | |
| | | sheet | | | | | | | | | | |
| | 19 | SPC | 500 | — | — | — | 100 | — | — | — | — | — |
| | | steel | | | | | | | | | | |
| | | sheet | | | | | | | | | | |
| | 20 | SPC | 250 | — | 500 | — | — | — | — | — | — | — |
| | | steel | | | | | | | | | | |
| | | sheet | | | | | | | | | | |
| | 21 | SPC | 250 | — | — | — | — | 500 | — | — | 200 | — |
| | | steel | | | | | | | | | | |
| | | sheet | | | | | | | | | | |
| | 22 | SPC | 250 | — | 500 | — | — | — | — | — | 200 | — |
| | | steel | | | | | | | | | | |
| | | sheet | | | | | | | | | | |
| | 23 | SPC | — | 100 | 100 | — | — | 100 | — | — | 30 | — |
| | | steel | | | | | | | | | | |
| | | sheet | | | | | | | | | | |
| | 24 | 6000 | 500 | — | — | — | — | 1000 | 500 | — | — | — |
| | | series | | | | | | | | | | |
| | | aluminum | | | | | | | | | | |
| | 25 | SPC | 500 | — | 1000 | — | — | 500 | — | — | — | — |
| | | steel | | | | | | | | | | |
| | | sheet | | | | | | | | | | |
| | 26 | GA steel | 4000 | — | — | 30 | — | — | — | 100 | — | 100 |
| | | sheet | | | | | | | | | | |
| | 27 | SPC | 1000 | 100 | 1000 | — | — | 500 | — | — | — | — |
| | | steel | | | | | | | | | | |
| | | sheet | | | | | | | | | | |
| | 28 | SPC | 200 | — | — | — | 100 | — | — | — | — | — |
| | | steel | | | | | | | | | | |
| | | sheet | | | | | | | | | | |

| | |
|---|---|
| Composition of treating agent (ppm) | Treatment condition |

| | | Sodium | | | Diethyl- | | | | | Temper- | |
|---|---|---|---|---|---|---|---|---|---|---|---|
| | | sili- | | | sili- | | Acceler- | | Time | ature | |
| | | cate | Al | In | cate | Cu | ator | pH | (sec) | (° C.) | Drying |
| Example | 16 | — | — | — | — | — | — | 4 | 60 | 40 | Air |
| | | | | | | | | | | | drying |
| | 17 | — | 30 | — | — | — | — | 2.5 | 30 | 40 | Air |
| | | | | | | | | | | | drying |
| | 18 | — | — | — | — | — | — | 4 | 60 | 40 | Air |
| | | | | | | | | | | | drying |
| | 19 | — | — | — | 100 | — | — | 4 | 60 | 40 | 80° C. |
| | 20 | — | — | — | — | — | A(200 | 4 | 60 | 40 | Air |
| | | | | | | | ppm) | | | | drying |
| | 21 | — | — | — | — | — | B(300 | 4 | 60 | 40 | None |
| | | | | | | | ppm) | | | | |
| | 22 | — | — | — | — | — | C(200 | 4 | 60 | 40 | 80° C. |
| | | | | | | | ppm) | | | | |
| | 23 | — | — | — | — | — | A(200 | 4 | 20 | 40 | Air |
| | | | | | | | ppm) | | | | drying |
| | 24 | — | — | — | — | — | E(100 | 4 | 60 | 25 | Air |
| | | | | | | | ppm) | | | | drying |
| | 25 | — | 100 | — | — | — | B(400 | 3.5 | 90 | 40 | None |
| | | | | | | | ppm) | | | | |
| | 26 | 30 | — | — | — | — | F(2500 | 3 | 90 | 35 | 80° C. |
| | | | | | | | ppm) | | | | |
| | 27 | — | — | 3 | — | — | G(800 | 4.5 | 60 | 40 | Air |
| | | | | | | | ppm) | | | | drying |
| | 28 | — | — | — | — | — | D(6000 | 4 | 60 | 40 | None |
| | | | | | | | ppm) | | | | |

TABLE 3

| | | | | | | | | | | | | | | Treatment condition | | |
|---|---|---|---|---|---|---|---|---|---|---|---|---|---|---|---|---|
| | | | Composition of treating agent (ppm) | | | | | | | | | | | | Temper- | |
| | | | | | | | | | SiO₂ | | | Accel- | | Time | ature | |
| | | Material | Zr | Ti | Zn | Mn | Co | Ca | (W) | Al | Cu | erator | pH | (sec) | (° C.) | Drying |
| Compar- | 1 | SPC steel | Treatment using zinc phosphate | | | | | | | | | — | — | 120 | 35 | Air |
| ative | | sheet | | | | | | | | | | | | | | drying |
| Example | 2 | GA steel | Treatment using zinc phosphate | | | | | | | | | — | — | 120 | 35 | Air |
| | | sheet | | | | | | | | | | | | | | drying |
| | 3 | 5000 | Treatment using zinc phosphate | | | | | | | | | — | — | 120 | 35 | Air |
| | | series | | | | | | | | | | | | | | drying |
| | | aluminum | | | | | | | | | | | | | | |
| | 4 | 6000 | Treatment using zinc phosphate | | | | | | | | | — | — | 120 | 35 | Air |
| | | series | | | | | | | | | | | | | | drying |
| | | aluminum | | | | | | | | | | | | | | |
| | 5 | SPC steel | 250 | — | — | — | — | — | — | — | — | — | 4 | 60 | 40 | None |
| | | sheet | | | | | | | | | | | | | | |
| | 6 | SPC steel | 20000 | — | — | — | 10000 | — | — | — | — | — | 4 | 1500 | 75 | None |
| | | sheet | | | | | | | | | | | | | | |
| | 7 | SPC steel | — | 10 | — | 0.5 | — | — | 0.5 | 1 | 0.1 | — | 4 | 60 | 40 | None |
| | | sheet | | | | | | | | | | | | | | |
| | 8 | SPC steel | — | 10 | — | 0.5 | — | — | 0.5 | 1 | 0.1 | — | 4 | 60 | 40 | 80° C. |
| | | sheet | | | | | | | | | | | | | | |
| | 9 | 5000 | 500 | — | — | — | 20000 | 10000 | — | 10000 | 300 | — | 4 | 60 | 40 | 80° C. |
| | | series | | | | | | | | | | | | | | |
| | | aluminum | | | | | | | | | | | | | | |
| | 10 | 6000 | 500 | — | — | — | 20000 | 10000 | — | 10000 | 300 | — | 4 | 60 | 40 | Air |
| | | series | | | | | | | | | | | | | | drying |
| | | aluminum | | | | | | | | | | | | | | |
| | 11 | GA steel | 500 | — | — | — | 20000 | 10000 | — | 10000 | 300 | — | 4 | 60 | 40 | 80° C. |
| | | sheet | | | | | | | | | | | | | | |
| | 12 | SPC steel | 250 | — | — | — | — | — | — | — | — | A(0.5 | 4 | 60 | 40 | None |
| | | sheet | | | | | | | | | | ppm) | | | | |
| | 13 | SPC steel | — | 10 | 0.5 | — | — | — | 0.5 | 1 | 0.1 | B | 4 | 60 | 40 | None |
| | | sheet | | | | | | | | | | (10000 | | | | |
| | | | | | | | | | | | | ppm) | | | | |

### Evaluation Test

### <Observation of Sludge>

After 1 m² of the surface of the metal material was treated per 1 liter of the chemical conversion coating agent, haze in the chemical conversion coating agent was visually observed.

◯: There is not haze
X: There is haze

Results of evaluation are shown in Table 4.

### <Secondary Adhesion Test (SDT)>

Two parallel lines, which have depth reaching the material, were cut in a longitudinal direction on the obtained test sheet and then the test sheet was immersed at 50° C. for 480 hours in 5% aqueous solution of NaCl. After immersion, a cut portion was peeled off with an adhesive tape and peeling of a coating was observed.

⊚: No peeled
◯: Slightly peeled
X: Peeled 3 mm or more in width

Results of observations are shown in Table 4.

TABLE 4

| | | | | Coat |
|---|---|---|---|---|
| | | | | amount |
| | | Sludge | SDT | (mg/m²) |
| Example | 1 | ◯ | ⊚ | 45 |
| | 2 | ◯ | ⊚ | 60 |
| | 3 | ◯ | ⊚ | 55 |
| | 4 | ◯ | ⊚ | 37 |
| | 5 | ◯ | ⊚ | 45 |
| | 6 | ◯ | ⊚ | 42 |
| | 7 | ◯ | ⊚ | 13 |
| | 8 | ◯ | ⊚ | 88 |
| | 9 | ◯ | ⊚ | 8.5 |
| | 10 | ◯ | ⊚ | 48 |
| | 11 | ◯ | ⊚ | 59 |
| | 12 | ◯ | ⊚ | 63 |
| | 13 | ◯ | ⊚ | 69 |
| | 14 | ◯ | ⊚ | 56 |
| | 15 | ◯ | ◯ | 29 |
| | 16 | ◯ | ⊚ | 47 |
| | 17 | ◯ | ⊚ | 16 |
| | 18 | ◯ | ⊚ | 53 |
| | 19 | ◯ | ◯ | 49 |
| | 20 | ◯ | ⊚ | 48 |
| | 21 | ◯ | ⊚ | 55 |
| | 22 | ◯ | ⊚ | 58 |
| | 23 | ◯ | ⊚ | 68 |
| | 24 | ◯ | ⊚ | 59 |
| | 25 | ◯ | ⊚ | 66 |
| | 26 | ◯ | ⊚ | 178 |
| | 27 | ◯ | ⊚ | 72 |
| | 28 | ◯ | ◯ | 1 |
| Comparative | 1 | X | ⊚ | 2200 |
| Example | 2 | X | ⊚ | 3100 |
| | 3 | X | ⊚ | 1600 |
| | 4 | X | ⊚ | 1800 |
| | 5 | ◯ | X | 25 |
| | 6 | X | X | 550 |
| | 7 | ◯ | X | 1.5 |
| | 8 | ◯ | X | 1.5 |
| | 9 | X | X | 44 |
| | 10 | X | X | 56 |
| | 11 | X | X | 68 |
| | 12 | ◯ | X | 25 |
| | 13 | ◯ | X | 2.5 |

Table 4 shows that there was not the formation of sludge in the chemical conversion coating agent of the present invention and the chemical conversion coat attained by the chemical conversion coating agent of the present invention has the good adhesion to a coating film even in an iron material. On the other hand, the chemical conversion coating agent obtained in Comparative Examples could not suppresses the formation of sludge and could not attain the chemical conversion coat which has excellent adhesion to a cationic electrodeposition coating film.

What is claimed is:

1. A method for coating a metal substrate comprising:
forming a chemical conversion coat on a surface of a metal substrate by subjecting said metal substrate at least a portion of which is an iron-based substrate to chemical conversion coating in a chemical conversion coating agent;
rinsing said metal substrate having said chemical conversion coat formed thereon; and then
applying a coating to said metal substrate having said chemical conversion coat formed thereon,
wherein said chemical conversion coating agent comprises:
at least one member selected from the group consisting of zirconium, titanium and hafnium;
fluorine; and
an adhesion and corrosion resistance imparting agent,
wherein said adhesion and corrosion resistance imparting agent comprises at least one member selected from the group consisting of:
1 to 5000 ppm (metal ion concentration) of at least one member of metal ion (A) selected from the group consisting of zinc ion, manganese ion and cobalt ion;
1 to 5000 ppm (metal ion concentration) of alkaline earth metal ion (B);
1 to 5000 ppm (metal ion concentration) of metal ion (C) of Group III in the periodic table;
0.5 to 100 ppm (metal ion concentration) of copper ion (D); and
1 to 5000 ppm of a silicon-containing compound (E) (as a silicon component); and
and wherein said chemical conversion coating agent has a pH of 1.5 to 6.5.

2. The method for coating according to claim 1, wherein said adhesion and corrosion resistance imparting agent comprises at least the component E.

3. The method for coating according to claim 2, wherein the component E is a silane coupling agent.

4. The method for coating according to claim 1, wherein said adhesion and corrosion resistance imparting agent comprises at least the component C.

5. The method for coating according to claim 4, wherein the component C is aluminum ion.

6. The method for coating according to claim 1, wherein said adhesion and corrosion resistance imparting agent comprises at least the component A and the component B.

7. The method for coating according to claim 4, wherein said adhesion and corrosion resistance imparting agent further comprises at least the component A and the component B.

8. The method for coating according to claim 6, wherein said adhesion and corrosion resistance imparting agent further comprises at least the component D.

9. The method for coating according to claim 7, wherein said adhesion and corrosion resistance imparting agent further comprises at least the component D.

10. The method for coating according to claim 7, wherein the component A is zinc ion, component B is magnesium ion and the component C is aluminum.

11. The method for coating according to claim 9, wherein the component A is zinc ion, component B is magnesium ion and the component C is aluminum.

12. The method for coating according to claim 1, wherein said adhesion and corrosion resistance imparting agent further comprises at least the component A and the component E.

13. The method for coating according to claim 1, wherein said adhesion and corrosion resistance imparting agent further comprises at least the component B and the component E.

14. The method for coating according to claim 1, wherein said adhesion and corrosion resistance imparting agent further comprises at least the component A, the component D and the component E.

15. The method for coating according to any one of claims 6 to 11, wherein said adhesion and corrosion resistance imparting agent further comprises at least the component E.

16. The method for coating according to any one of claims 1 to 11, wherein said chemical conversion coating agent comprises substantially no phosphate ion.

17. The method for coating according to any one of claims 1 to 11, wherein said chemical conversion coating is coated on said metal substrate at a coating temperature of 20 to 70° C. for 5 to 1200 seconds.

18. The method for coating according to any one of claims 1 to 11, wherein said coating is a cation electrocoating.

19. The method for coating according to claim 17, wherein said coating is a cation electrocoating.
